(19) United States
(12) Patent Application Publication
(10) Pub. No.: US 2009/0094551 A1
(43) Pub. Date: Apr. 9, 2009

(54) ENHANCEMENTS TO PREVENT SPLIT ENTRIES IN THE EVENT OF A WINDOW FOCUS SHIFT

(75) Inventors: Christopher S. Alkov, Austin, TX (US); Travis M. Grigsby, Austin, TX (US); Ruthie D. Lyle, Durham, NC (US); Lisa A. Seacat, San Francisco, CA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/868,314

(22) Filed: Oct. 5, 2007

(51) Int. Cl. G06F 3/048

(52) U.S. Cl. 715/802

(57) ABSTRACT

The present invention discloses a solution to prevent split entries in an event of a window focus shift while still permitting the focus shift event to occur. The solution utilizes a number of different configurable techniques to accomplish this goal, all of which are designed to permit a user to finish directing input to an original window element, when an automatic focus shift event occurs that directs focus to a different window element. Techniques for preventing split entries can include, but are not limited to, a pause-triggered target shifting technique, a pause-triggered focus shifting technique, a password control focus retention technique, a password control focus shift alter technique, an entry continuation blocking after focus shift technique, an entry continuation alert after focus shift technique, and an entry continuation buffering after focus shift technique. The solution is not to be construed limited to these enumerated techniques.

### BACKGROUND

1. Field of the Invention

The present invention relates to interface technologies, and more particularly, to enhancements to prevent split entries in the event of a window focus shift.

2. Description of the Related Art

An operating system (OS) is the software that manages the sharing of the resources of a computer. Most operating systems come with an application that provides a user interface for managing the OS, such as a command line interpreter or graphical user interface (GUI). Most GUI OS's have a multitasking capability, in which multiple tasks share common processing resources, such as a central processing unit (CPU). Different windows in a GUI can be simultaneously present in a multitasking GUI OS. A property called focus refers to which of many windows and/or window elements is being interacted with. For example, a window element having focus is typically one that receives user entered input from a keyboard.

In many OS's, applications can grab focus from other applications, which can be troublesome. For example, if a user is typing their password into a GUI element of one window and a new window receives focus, part or all of their password can be sent to the newly run application. This situation is illustrated in FIG. 1 (Prior Art), which shows an original desktop interface 110 including an application interface 110 in which a user is typing a password into GUI element 115. While typing, a new application interface 125 grabs focus and is placed “on top” of the window stack, as shown by desktop interface 120. The new application interface 125 can, for example, be an instant messaging application, which is one type of application that commonly appears and seizes focus when new messages are received. Assuming the user continues typing their password, which is intended for GUI element 115, part of the password is placed in GUI element 130, which is the default focus element for window 125. For example, assuming a password is “password123,” the first three letters (“pas”) can appear in GUI element 115 and the last eight letters (“sword123”) can appear in GUI element 130. Not only is this annoying to users, but it can also pose a security risk of exposing otherwise protected information, such as a password, which can be partially conveyed from interface 125 if a user hits an “enter” key after entering the password.

Present solutions to a problem of input handling during a focus grabbing situation provide settings for disabling focus seizure from one application to another. These solutions, however, disable a useful function of an operating system, which other than potential input problems is generally desirable. What is needed is an enhancement that prevents split entries from occurring during a focus shift situation, which nevertheless permits focus shifting to occur.

### SUMMARY OF THE INVENTION

The present invention discloses a solution to prevent split entries in an event of a window focus shift while still permitting the focus shift event to occur. The solution utilizes a number of different configurable techniques to accomplish this goal, all of which are designed to permit a user to finish directing input to an original window element, when an automatic focus shift event occurs that directs focus to a different window element. Techniques for preventing split entries can include, but are not limited to, a pause-triggered target shifting technique, a pause-triggered focus shifting technique, a password control focus retention technique, a password control focus shift alter technique, an entry continuation blocking after focus shift technique, an entry continuation alert after focus shift technique, and an entry continuation buffering after focus shift technique. The solution is not to be limited to these enumerated techniques, however, and derivative and similar techniques are to be considered to be within the scope of the present solution.

To elaborate on the aforementioned techniques, in pause-triggered target shifting, when an application takes focus from another, the operating system (OS) can continue sending keyboard and other entry events to the previous application until a pre-determined pause length has occurred in the input. Therefore, when a new window receives focus, the input can continue to be sent to the previous application until the input has paused for a pre-determined length of time.

In pause-triggered focus shifting, when an application requests focus, the OS can wait to transfer focus until input is paused for a pre-determined length of time.

In password control focus retention, the OS can determine when input is being entered into a password field and the OS can block the focus shift. In some embodiments, the focus shift can be blocked altogether. In other embodiments, the focus shift can be blocked until entry is completed in the password field.

In password control focus-shift alerts, when a user is entering data into a password field, the OS can play an audio or other notification informing the user that the focus is about to shift before focus is shifted.

In entry continuation blocking after focus shift, when the OS shifts focus from an application, the application can block any input received before a pre-determined pause length has occurred in the input.

In entry continuation alert after focus shift, when the OS shifts focus from an application, any entry occurring before a pre-determined pause length can result in an audio or other notification being played to inform the user that input is being sent to the wrong window. In some embodiments, when the notification is presented, the input can also be blocked.

In entry continuation buffering after focus shift, when the OS shifts focus from an application, any input is stored in a buffer. The user can then be presented with options to pass the contents of the buffer to the application that had focus, to the application that received focus, or to dump the contents of the buffer.

For each of the techniques for preventing split entries, it is contemplated that the pause length may not be pre-determined and can be automatically detected. For example, an application can detect the user's typing speed and length between key presses. The application can use this information to determine a suitable pause length for split entry blocking. It is also contemplated that when providing alerts to the user, visual indications such as transparency can be used. For example, when a window receives focus and the OS will send keyboard events to the previously focused window (as in pause-triggered target shifting), the OS can indicate that focus is still being sent to the previous application by making the window that is about to receive focus translucent, then making it opaque once the user pauses for the determined length of time and the focus is shifted. It is further contemplated that in the event of an audible warning that focus is about to change, it can be desirable to provide a configurable key stroke or key combo to enable or prevent the focus shift.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (Prior Art) illustrates a conventional application interface in which split entries can occur during a window focus shift.

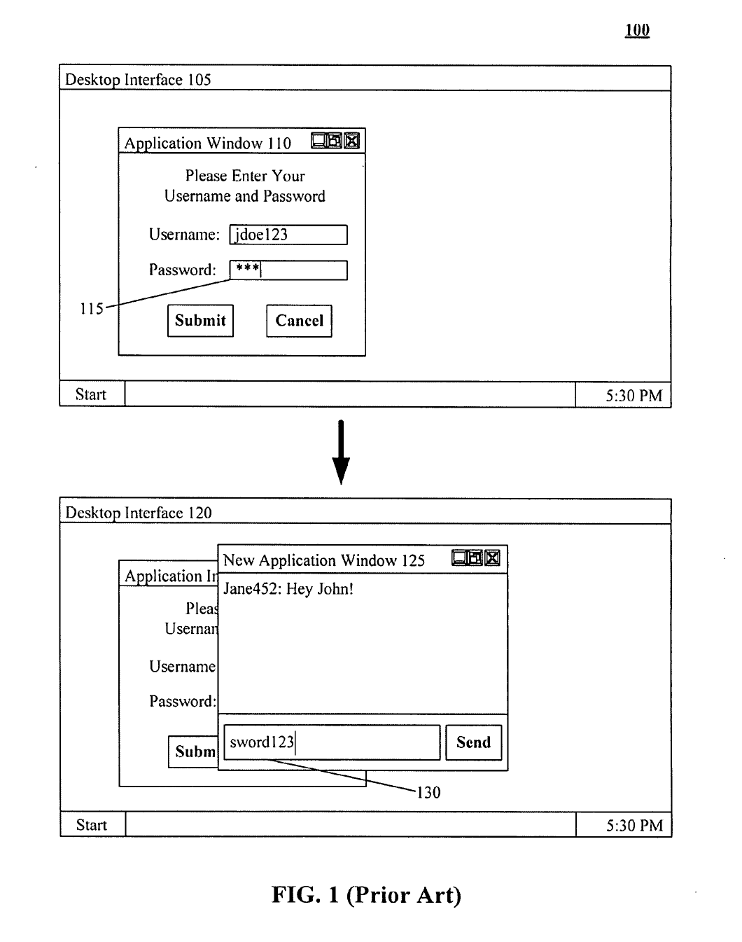

FIG. 2 is a schematic diagram of a system for enhancements to prevent split entries during the event of a window focus shift in accordance with an embodiment of the inventive arrangements disclosed herein.

FIG. 3 illustrates a set of flow charts for enhancements to prevent split entries during the event of a window focus shift in accordance with an embodiment of the inventive arrangements disclosed herein.

FIG. 4 illustrates a further set of flow charts for enhancements to prevent split entries during the event of a window focus shift in accordance with an embodiment of the inventive arrangements disclosed herein.

### DETAILED DESCRIPTION OF THE INVENTION

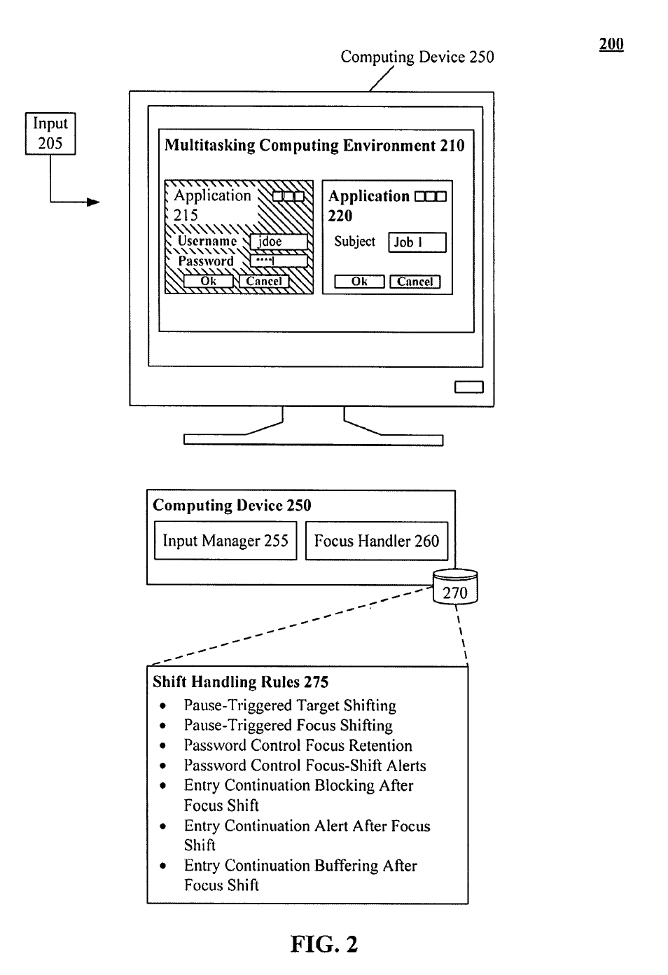

FIG. 2 is a schematic diagram of a system 200 of a computing device for enhancements to prevent split entries during the event of a window focus shift in accordance with an embodiment of the inventive arrangements disclosed herein. System 200 includes computing device 250, which can run multitasking computing environment 210, such as a graphical user interface (GUI) based multitasking Operating System (OS). Multitasking computing environment 210 can run application 215 and application 220. In system 200, multitasking computing environment 210 can be provided with input 205 from an external source, such as input provided by a user through an externally connected peripheral.

In multitasking computing environment 210, application 215 can initially have focus. When application 220 is instantiated while input 205 is being provided to application 215, the application 220 can attempt to seize focus control, which initiates a shift focus event. An input manager 255 and a focus handler 260 can work together to ensure that input 205 is not split between the windows 215 and 220 as a result of the shift focus event. The input manager 250 and focus handler 260 can be software programs stored in data store 270, which a computing device 250 executes. Numerous configurable rules 275 that utilize different techniques can be enabled to prevent input splitting. The techniques can include, for example, a pause-triggered target shifting technique, a pause-triggered focus shifting technique, a password control focus retention technique, a password control focus shift alter technique, an entry continuation blocking after focus shift technique, an entry continuation alert after focus shift technique, and an entry continuation buffering after focus shift technique.

The input manager 255 can be configured to parse and interpret input 205. Input 205 can also be cached in data store 270 as input manager 255 and focus handler 260 determine a suitable application 215, 220 target for the input 205.

The focus handler 260 can determine which application should receive focus and when in accordance with a set of shift handling rules 275. For example, if application 215 has focus and application 220 runs and wants focus while a user is typing in a password field, focus handler 260 can find a rule that pertains to the situation in shift handling rules 275. In this case, the focus handler can use password control focus retention to block the focus shift to allow the user to continue typing in the password field.

Computing device 250 can be any computing device capable of running a multitasking computing environment 210 that is capable of running applications 215 and 220. Computing device 250 can also be capable of receiving and interpreting input 205. Computing device 250 can also contain input manager 255, focus handler 260, and data store 270 to prevent split entries in the event of a focus shift in multitasking computing environment 210. Computing device 250 can be any computing device including, but not limited to, a personal computer, a personal data assistant (PDA), a server computer, a mobile phone, a gaming system, and the like.

Input 205 can be any input that can be provided to computing device 250 via any medium. Input 205 can provide input that can interact with multitasking computing environment 210 and the running applications 215 and 220. Input 205 can be provided by a user through an external peripheral such as a keyboard or mouse (not shown). In some embodiments, Input 205 can be provided through a touch screen interface embedded in computing device 250. Input 205 can be implemented in any way necessary to provide input to computing device 250 for interaction with multitasking computing environment 210 and the running applications 215 and 220.

Application 215 and application 220 can be any application designed to be run in multitasking computing environment 210. Application 215 and application 220 can be designed to interact with a user through input 205 and allow the user to perform computing actions performable by a computing device 250. Application 215 and application 220 can be implemented as machine-readable instruction code for performing the necessary steps to perform an operation.

Input manager 255 can be an engine used to receive, parse, and interpret input 205. Input manager 255 can allow the interaction between a user and multitasking computing environment 210, and its running applications 215 and 220. For example, a user can provide the input to start a new application, close a running application, or the like. A user can provide input 205 to input manager 255 to instantiate application 220 after application 215 is running. When application 220 is instantiated, focus handler 260 can manage which application will receive focus. Input manager 255 can also receive input 205 to manually switch focus. In some embodiments, input manager 255 can be embedded in the multitasking computing environment 210.

Focus handler 260 can be an engine used to determine which application will receive focus to prevent split entries in the event of a focus shift. In multitasking computing environment 210, application 215 can be a previously run application and application 220 can be a newly run application. In this case, focus handler 260 can interact with data store 270 and look up shift handling rules 275 to determine the necessary action for handling the focus shift. Focus handler 260 can be machine-readable instructions for determining and processing focus shifts in multitasking computing environment 210. Focus handler 260 can use shift handling rules 275 to prevent split entries in the event of a focus shift.

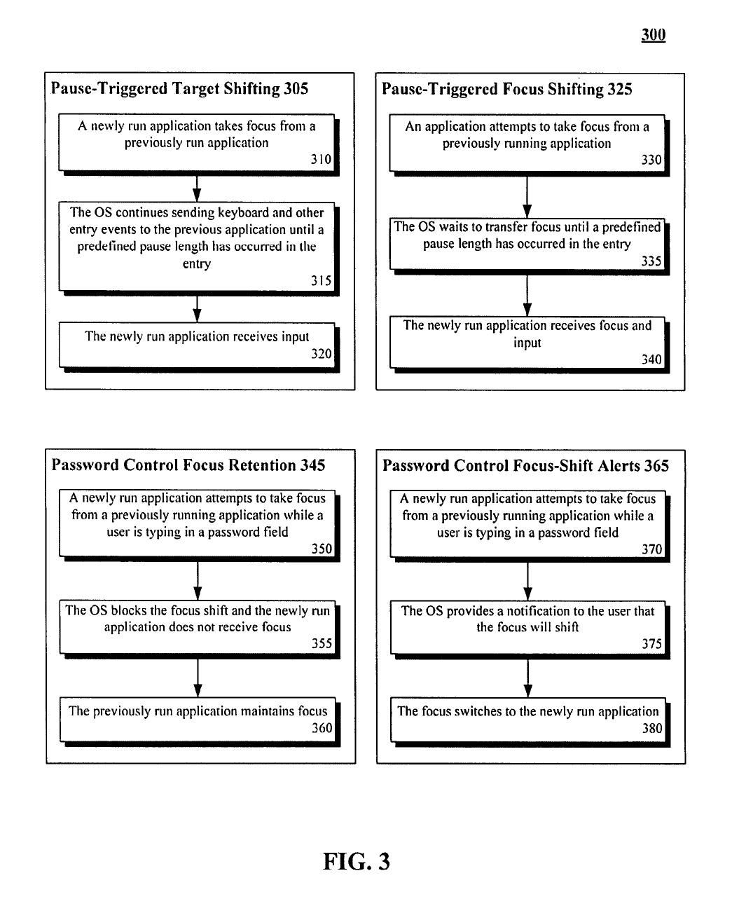

FIG. 3 illustrates a set 300 of flow charts for enhancements to prevent split entries during the event of a window focus shift in accordance with an embodiment of the inventive arrangements disclosed herein. The set 300 of flow charts contains four separate solutions (solutions 305, 325, 345, and 365) for preventing split entries in the event of a window focus shift. The set 300 of flow charts are each techniques able to be performed in a context of system 200 or a similar system in which event focus shifting can be problematic.

The pause-triggered target shifting 305 solution can begin in step 310, where a newly run application can take focus from a previously run application. In step 315, the operating system (OS) can continue to send keyboard and other entry events to the previously run application until a predefined pause length has occurred in the entry. Pause-triggered target shifting 305 can end in step 320, where the newly run application can receive focus and all further input.

The pause-triggered focus shifting 325 solution can begin in step 330, where an application can attempt to take focus from a previously running application. In step 335, the OS can wait to transfer focus until a predefined pause length has occurred in the entry. In step 340, the new application (the one attempting to take focus) receives focus, which permits it to receive input.

The password control focus retention 345 solution can begin in step 350, where a newly run application can attempt to take focus from a previously run application while a user is typing in a password field. In step 355, the OS can block the focus shift and the newly run application can remain unfocused. In step 360, the previously run application can maintain focus and can continue to receive input.

The password control focus-shift alerts 365 solution can begin in step 370, where a newly run application can attempt to take focus from a previously run application while a user is typing in a password field. In step 375, the OS can provide a notification to the user that the focus will shift. The provided notification can be implemented in many ways, including, but not limited to, a audible notification, a visual notification, both, or the like. In some embodiments, a key combo can be configured which can either enable or disable the focus shift. In step 380, the focus can switch to the newly run application and it can receive all further input.

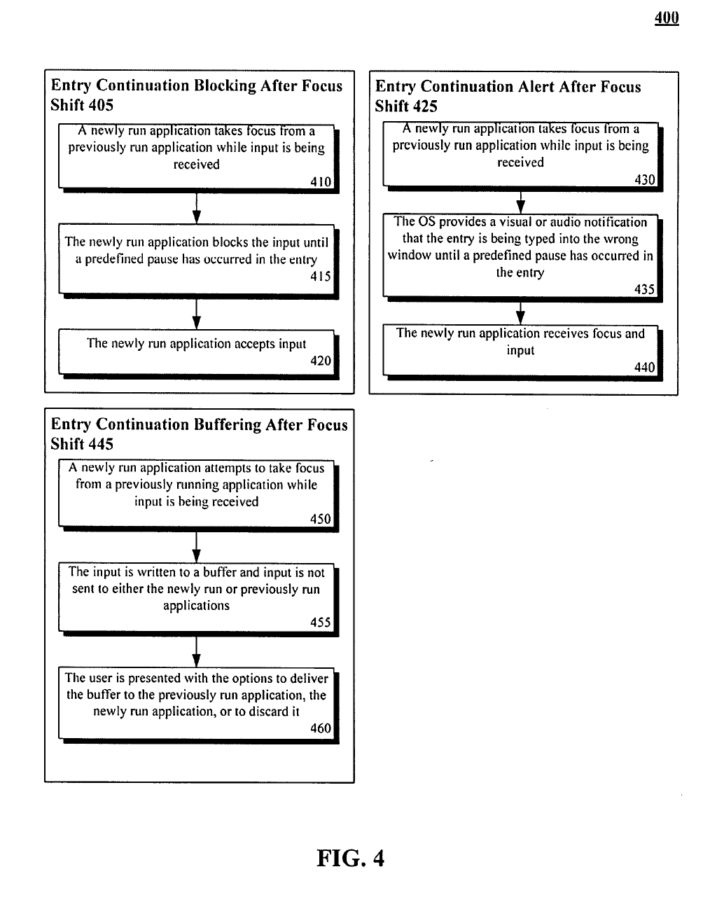

FIG. 4 illustrates a further set 400 of flow charts for enhancements to prevent split entries during the event of a window focus shift in accordance with an embodiment of the inventive arrangements disclosed herein. The set 400 of flow charts contains three separate solutions (solutions 405, 425, 445) for preventing split entries in the event of a window focus shift. The set 400 of flow charts are each techniques able to be performed in a context of system 200 or a similar system in which event focus shifting can be problematic.

The entry continuation blocking after focus shift 405 solution can begin in step 410, where a newly run application can take focus from a previously run application while input is being received. In step 415, the newly run application can block the input until a predefined pause length has occurred in the entry. Entry continuation blocking after focus shift 405 can complete in step 405, where the newly run application can receive focus and all further input.

The entry continuation alert after focus shift 425 solution can begin in step 430, where a newly run application can take focus from a previously run application while input is being received. In step 435, the OS can provide a visual or audio notification that the entry is being typed into the wrong window until a predefined pause has occurred in the entry. At this point, the input can be blocked and not sent to either application. In other embodiments, the entry may be allowed and sent to either the previously run application or the newly run application. Entry continuation alert after focus shift 425 can end in step 440, where the newly run application can receive focus and all further input.

The entry continuation buffering after focus shift 445 solution can begin in step 450, where a newly run application can attempt to take focus from a previously running application while input is being received. In step 455, the input can be written to a buffer and input can be blocked to both the newly run or previously run applications. In step 460, the user can be presented with the options to deliver the buffer to the previously run application, to deliver the buffer to the newly run application, or to discard the buffer entirely.

It should be emphasized that the solutions 305, 325, 345, 365, 405, 425, and 445 illustrate species of solutions that are part of an overall genus of solutions for permitting focus shifting while preventing split entries. Other solutions, such as combinations, derivatives, and alternatives of the expressed solutions 305, 325, 345, 365, 405, 425, and 445 are contemplated. Additionally, for each of the solutions 305, 325, 345, 365, 405, 425, and 445, it is contemplated that the pause length may not be pre-determined and can be automatically detected. For example, an application can detect the user's typing speed and length between key presses. The application can use this information to determine a suitable pause length for split entry blocking. It is also contemplated that when providing alerts to the user, visual indications such as transparency can be used. For example, when a window receives focus and the OS will send keyboard events to the previously focused window (as in pause-triggered target shifting), the OS can indicate that focus is still being sent to the previous application by making the window that is about to receive focus translucent, then making it opaque once the user pauses for the determined length of time and the focus is shifted. It is further contemplated that in the event of an audible warning that focus is about to change, it can be desirable to provide a configurable key stroke or key combo to enable or prevent the focus shift.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method for preventing a focus shift event from resulting in split entries comprising:
detecting a focus shift event within a multitasking computing environment having a graphical user interface;
accessing at least one shift handling rule; and
executing programmatic actions consistent with the shift handling rule to prevent split entries while still permitting a focus shift to occur, wherein a split entry occurs when an input set intended for one graphical user interface input element is separated into two input subsets, one input subset being placed in the intended graphical user interface input element and another input subset being placed in a different graphical user interface input element.

2. The method of claim 1, wherein said at least one shift handling rule comprises one items from a group consisting of a pause-triggered target shifting rule, a pause-triggered focus shifting rule, a password control focus retention rule, a password control focus shift alter rule, an entry continuation blocking after focus shift rule, an entry continuation alert after focus shift rule, and an entry continuation buffering after focus shift rule.

3. The method of claim 1, wherein said at least one shift handling rule comprises a plurality of user configurable shift handling rules, wherein behavior of the method is dependant upon which of the plurality of user configurable shift handling rules is indicated by a user established setting.

4. The method of claim 3, wherein said plurality of user configurable shift handling rules comprise at least three items from a group consisting of a pause-triggered target shifting rule, a pause-triggered focus shifting rule, a password control focus retention rule, a password control focus shift alter rule, an entry continuation blocking after focus shift rule, an entry continuation alert after focus shift rule, and an entry continuation buffering after focus shift rule.

5. The method of claim 3, wherein the focus shift event is an automatically triggered event, which is not a result of a user interface selection to shift focus.

6. The method of claim 1, wherein said executed programmatic actions cause input to continue to be directed to an initial graphical user interface element having focus immediately before an occurrence of the focus shift event until a previously established pause duration between input items expires.

7. The method of claim 6, wherein the shift occurs after the occurrence of the focus shift event and before the pause duration expires.

8. The method of claim 6, wherein the shift occurs after the occurrence of the focus shift event and after the pause duration expires.

9. The method of claim 1, wherein said executed programmatic actions determine whether an initial graphical user interface element currently having focus is associated with a password input field, when determination results are negative, permitting the focus shift to immediately occur, when determination results are affirmative, preventing the focus shift from occurring until at least a previously determined duration expires.

10. The method of claim 1, wherein said executed programmatic actions present an audible indicator indicating that a focus is about to shift before the focus is actually shifted responsive to the focus shift event.

11. The method of claim 1, wherein said executed programmatic actions cause a focus to shift from an initial graphical user interface element to a new graphical user interface element, preventing input items from being added to the new graphical user interface element for a previously established duration after a focus shift to the new graphical user interface element occurs.

12. The method of claim 1, wherein said executed programmatic actions cause focus to shift, and wherein input received for a previously established duration after the focus has shifted is stored in a buffer, wherein a user input determines whether the buffered input is to be placed in an initial graphical user interface element having focus before the focus shift occurred or whether the buffered input is to be placed in a new graphical user interface element having focus after the focus shift occurred.

13. The method of claim 1, wherein said steps of claim 1 are performed by at least one machine in accordance with at least one computer program stored in a computer readable media, said computer programming having a plurality of code sections that are executable by the at least one machine.

14. A graphical user interface enhancement comprising:
a focus shifting capability that prevents an occurrence of split input entries caused by an automatic focus shift while still permitting the automatic focus shift to occur, wherein a split entry occurs when an input set intended for one graphical user interface input element is separated into two input subsets, one input subset being placed in the intended graphical user interface input element and another input subset being placed in a different graphical user interface input element, wherein said focus shifting capability is implemented within software stored on a medium readable by a computing device.

15. The graphical user interface enhancement of claim 14, wherein the focus shifting capability uses a technique for preventing split input entries selected from a group consisting of a pause-triggered target shifting technique, a pause-triggered focus shifting technique, a password control focus retention technique, a password control focus shift alter technique, an entry continuation blocking after focus shift rule, an entry continuation alert after focus shift technique, and an entry continuation buffering after focus shift technique.

16. A method for handling focus shifts comprising:
detecting a focus shift event; and
executing a input splitting prevention action responsive to the focus shift event, wherein said input splitting prevention action implements one technique selected from a group of techniques consisting of a pause-triggered target shifting technique, a pause-triggered focus shifting technique, a password control focus retention technique, a password control focus shift alter technique, an entry continuation blocking after focus shift rule, an entry continuation alert after focus shift technique, and an entry continuation buffering after focus shift technique.

17. The method of claim 16, further comprising:
determining which of a plurality of different input splitting prevention actions to take based upon a previously established user configured setting, wherein different settings exist for at least two techniques selected from a group of techniques consisting of a pause-triggered target shifting technique, a pause-triggered focus shifting technique, a password control focus retention technique, a password control focus shift alter technique, an entry continuation blocking after focus shift rule, an entry continuation alert after focus shift technique, and an entry continuation buffering after focus shift technique.

18. The method of claim 16, further comprising:
determining which of a plurality of different input splitting prevention actions to take based upon a previously established user configured setting, wherein different settings exist for each of the techniques selected from a group of techniques consisting of a pause-triggered target shifting technique, a pause-triggered focus shifting technique, a password control focus retention technique, a password control focus shift alter technique, an entry continuation blocking after focus shift rule, an entry continuation alert after focus shift technique, and an entry continuation buffering after focus shift technique.

19. The method of claim 16, wherein said steps of claim 16 are performed by at least one machine in accordance with at least one computer program stored in a computer readable media, said computer programming having a plurality of code sections that are executable by the at least one machine.
